(19) United States
(12) Patent Application Publication
(10) Pub. No.: US 2026/0298224 A1
(43) Pub. Date: Oct. 1, 2026

(54) PUMP FOR CRYOGENIC LIQUID

(71) Applicant: FIVES CRYOMEC AG, Allschwil (CH)

(72) Inventors: Stéphane BOEGLIN, Allschwil (CH); Félicien GEBEL, Allschwil (CH); Pierre-Yves DUVIVIER, Allschwil (CH)

(21) Appl. No.: 18/992,377

(22) PCT Filed: Jun. 23, 2023
(86) PCT No.: PCT/EP2023/067111

§ 371 Date: Jan. 8, 2025

(30) Foreign Application Priority Data
Jul. 13, 2022 (FR) FR2207217

(51) Int. Cl. F04B 53/16; F04B 15/08; F16J 15/06; F16J 15/10

(52) U.S. Cl. CPC F04B 53/16; F04B 15/08; F16J 15/062; F16J 15/102; F04B 2015/0822

(57) ABSTRACT

A pump for cryogenic liquids, comprising at least one static seal able to provide sealing between a first mechanical component and a second mechanical component, the first mechanical component having a duct intended to contain a cryogenic liquid, with an opening in one end of the first mechanical component, said end of the first mechanical component having a contact surface, the seal having a first face bearing against the contact surface of the first mechanical component and a second face bearing against a contact surface of the second mechanical component located at one end of said second mechanical component, wherein the contact surface of the first mechanical component comprises at least one closed groove surrounding the opening in the end of the first mechanical component.

### DESIGNATION OF THE TECHNICAL FIELD CONCERNED

The present invention relates to cryogenic installations for production, storage or use of a cryogenic liquid. It particularly concerns pumps that ensure the flow of cryogenic liquid in said installations. The invention is particularly suited to pumps for liquid hydrogen.

### TECHNICAL PROBLEMS ADDRESSED BY THE INVENTION

A pump for cryogenic liquids includes several static seals that ensure the pump's seal against its external environment, or between internal compartments of the pump. These seals generally have a toric shape inside which cryogenic liquid can be found. The seal is maintained between the contact surfaces by two or more elements depending on the nature of the seal, its housing and the location of the seal in the pump. For example, a seal can be placed between two parallel surfaces with only two contact surfaces on either side of it, it can be placed in a triangular section groove with 3 contact surfaces, or even be placed in a rectangular section groove, with 4 contact surfaces.

In cryogenic pumps according to the state of the art, between two parallel contact surfaces, copper seals or energized seals are generally found, for example lip seals with a spring.

The support surfaces for static seals of cryogenic pumps according to the state of the art can be smooth surfaces but with machining marks. These surfaces are generally obtained by turning or milling.

The advance of the cutting tool during machining forms spiral-shaped marks creating a leak path for the cryogenic liquid.

The contact surfaces for static seals of cryogenic pumps according to the state of the art can also have smooth surfaces, without apparent machining marks. They are for example obtained by a first turning or milling operation followed by rectification.

This type of surface condition is advantageous due to the absence of machining marks but any impurity between the seal and the static seal will create a leak path. Similarly, surface marking by an object, a scratch, for example during pump assembly, handling or maintenance, can also create a leak path for the cryogenic liquid.

These surfaces can therefore be altered over time. Thus, the slightest imperfection can lead to a non-negligible leak rate.

Leak paths of small dimensions may not be problematic for certain cryogenic liquids but they are for hydrogen due to the small size of the hydrogen molecule.

The seals used in cryogenic pumps are generally made of copper. Due to copper's limited elastic limit, the presence of an impurity between the seal and its contact surface can accentuate the risk of a leak.

The invention provides a new solution to this problem.

### SUMMARY OF THE INVENTION

According to the invention, a cryogenic liquid pump is proposed comprising at least one static seal intended to ensure sealing between a first mechanical component and a second mechanical component, the first mechanical component having a duct intended to contain the cryogenic liquid with an opening in one end of the first mechanical component, said end of the first mechanical component having a contact surface, the seal having a first face in contact with the contact surface of the first mechanical component and a second face in contact with a contact surface of the second mechanical component arranged at one end of said second mechanical component, characterized in that the contact surface of the first mechanical component comprises at least one closed groove surrounding the opening in the end of the first mechanical component and in that the second mechanical component has a duct intended to contain the cryogenic liquid with an opening in the end of the second mechanical component, the seal having an opening connecting the openings of the first and second mechanical component, and in that the contact surface of the second mechanical component comprises at least one closed groove surrounding the opening in the end of the second mechanical component.

Advantageously according to the invention, the contact surface of the first mechanical component includes a plurality of successive closed grooves starting from the opening of the duct of the first mechanical component, the first groove being closest to the opening, the second groove and subsequent ones surrounding the groove(s) positioned closer to the opening of the duct of the first mechanical component.

The closed groove(s) have, for example, been formed by a cutting tool during a machining operation. For example, the closed grooves are formed by the cutting tool during machining by turning the contact surface. To obtain these closed grooves, the tool advances toward the duct, or from the duct, in such a way that the cutting edge of the tool emerges from the surface. The machining is thus performed through a succession of successive machining steps. Let's take the example where machining of the support surface is performed from its exterior, that is, from the point most radially distant from the duct. When it is in position to retract from the surface to be machined, the cutting tool is positioned radially at a first position. The tool is then advanced toward the surface to perform a first machining operation. Once this is completed, the tool is retracted from the support surface then moved radially to a second position, closer to the duct. The tool is then advanced toward the surface to perform a second machining operation. The operation is repeated as many times as necessary to machine the entire support surface.

The importance of the tool's radial displacement between two machining operations, and the penetration depth of the tool during machining, are adapted according to the shape and dimensions of the tool's cutting surface to obtain machining of the entire support surface. This will include as many closed grooves as there are operations of radial displacement of the tool in retracted position followed by machining.

Advantageously, the contact surface of the second mechanical component includes a plurality of successive closed grooves starting from the opening of the second mechanical component, the first groove being closest to the opening, the second groove and subsequent ones of the contact surface of the second mechanical component surrounding the groove(s) of the second mechanical component's contact surface positioned closer to the opening in the end of the second mechanical component.

The presence of closed grooves according to the invention on both opposing contact surfaces between which the seal is positioned allows ensuring sealing on both sides of the seal.

Advantageously, the closed grooves are concentric. They can also be circular. The distance between two adjacent closed grooves can be the same for all closed grooves present on a bearing surface.

Advantageously, the closed grooves form closed channels delimited by protruding edges. These imprint into the seal through local deformation of it due to the compression of the seal resulting from the tightening force exerted by the two support surfaces. The edges thus form successive barriers that block the escape of cryogenic liquid.

Advantageously, the static seal also ensures sealing with a third mechanical component, the seal having a third face in contact with a contact surface of the third mechanical component, characterized in that the contact surface of the third mechanical component is devoid of grooves.

Depending on its nature and location in the pump, the static seal can also ensure sealing with a third mechanical component, the seal having a third face in contact with a contact surface of the third mechanical component, the pump being characterized in that the contact surface of the third mechanical component is devoid of grooves. This type of seal is found particularly between the head and the liner, and the liner and the pump cylinder. The housing wherein the seal is placed, formed by the three mechanical components, is advantageously triangular in section, just like the seal. In this case, the static seal advantageously forms a triangular section torus.

Advantageously, the static seal is made of polymer. Polymers have an elastic limit that is higher than that of copper. Moreover, they resist cryogenic temperatures perfectly. They have superior sealing characteristics compared to metals. They handle traction and creep well. Using a polymer also helps compensate for any imperfections that may be present on the support surfaces of static seals. The polymer has plasticity and mechanical properties that allow it to better conform to these imperfections than copper, which improves sealing at the static seal.

Advantageously, the static seal can be made of Polytetrafluoroethylene (PTFE), or Polychlorotrifluoroethylene (PCTFE), or polyimide. These materials are advantageous particularly because their dilation coefficients are low compared to other polymers. The static seal is thus better able to maintain good dimensional stability even when subjected to temperatures ranging from cryogenic temperatures to ambient temperatures.

A pump according to the invention is particularly suitable for pumping liquid hydrogen.

### BRIEF DESCRIPTION OF THE FIGURES

Other characteristics and advantages of the invention will appear during the reading of the detailed description that follows, for the understanding of which one will refer to the annexed drawings wherein:

FIG. 1 is a schematic and partial view, in cross-section, of a pump at the level of a static seal placed between two contact surfaces wherein the static seal serves to obstruct a duct, the seal being in working position;

FIG. 2 is a schematic and partial view of a pump at the level of a static seal according to FIG. 1, in exploded view at the seal level for better visualization of the seal's contact surfaces;

FIG. 3 is a schematic and partial view, in cross-section, of a pump at the level of a static seal placed between two contact surfaces according to an example of the invention's implementation wherein the static seal ensures sealing during the continuity of a duct between two components, the seal being in working position;

FIG. 4 is a schematic and partial view of a pump at the level of a static seal according to FIG. 3, in exploded view at the seal level for better visualization of the seal's contact surfaces;

FIG. 5 is a schematic and partial view, in cross-section, of a pump at the level of a static seal placed between three contact surfaces according to an example of the invention's embodiment wherein the static seal ensures sealing during the continuity of a duct between two components, the seal being in working position;

FIG. 6 is a schematic and partial view of a pump at the level of a static seal according to FIG. 5, in exploded view at the seal level for better visualization of the seal's contact surfaces;

FIG. 7 is a schematic and partial view, in top view, of a contact surface comprising grooves according to an example of the invention's embodiment; and

FIG. 8 is a schematic and partial view, in cross-section, of the contact surface of FIG. 7.

### DETAILED DESCRIPTION

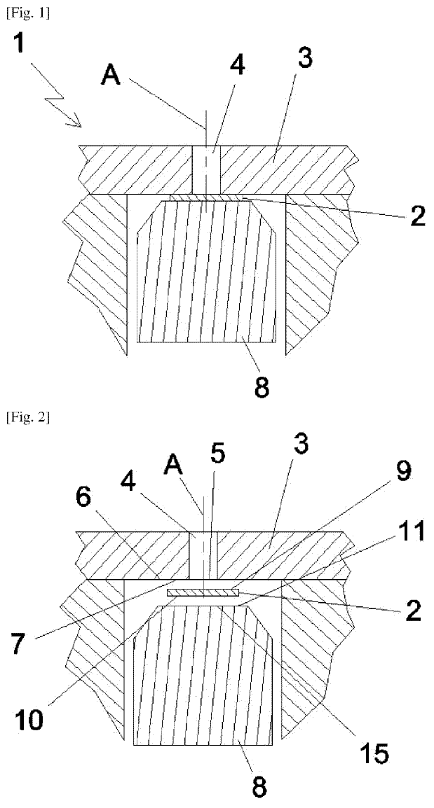

Referring to FIG. 1, one can see a flat static seal 2 placed between a first mechanical component 3 and a second mechanical component 8, wherein the static seal serves to obstruct a duct 4 having an axis A, intended to receive a cryogenic fluid, of the first component 3, the seal being shown in working position.

Referring to FIG. 2, one can see the same flat static seal 2 as in FIG. 1, but in an assembly position facilitating the description of the invention. The duct 4 has an opening 5 in one end 6 of the first mechanical component, said end 6 of the first mechanical component having a contact surface 7, the seal having a first face 9 bearing against the contact surface 7 of the first mechanical component 3 and a second face 10 bearing against a contact surface 11 of the second mechanical component 8 arranged at one end 15 of said second mechanical component.

The seal includes a first face 9 intended to bear against a contact surface 7 of the first component 3. It also includes a second face 10 intended to bear against a contact surface 11 of the second component 8. The contact surface 7 of the first mechanical component includes closed grooves according to the invention. The contact surface 11 of the second mechanical component does not need to have closed grooves according to the invention as it does not have to ensure a sealing function. After positioning the seal between the two mechanical components, a tightening force is applied by the two mechanical components to compress the seal. The seal being made of polymer, it deforms during compression. As shown in FIG. 8, the closed grooves present on contact surface 7 include a protruding edge forming a closed ridge 18 between two closed channels 17. The compression of the seal and its elastic material allow seal face 9 to perfectly match the contact surface of the first mechanical component 3. Thus, the seal fills the channels 17 and the protruding edges imprint into the seal forming successive barriers, these being as many obstacles to the flow of liquid between face 9 of the seal and contact surface 7 of the first mechanical component. The seal thus allows completely obstructing opening 5 of duct 4 of the first mechanical component.

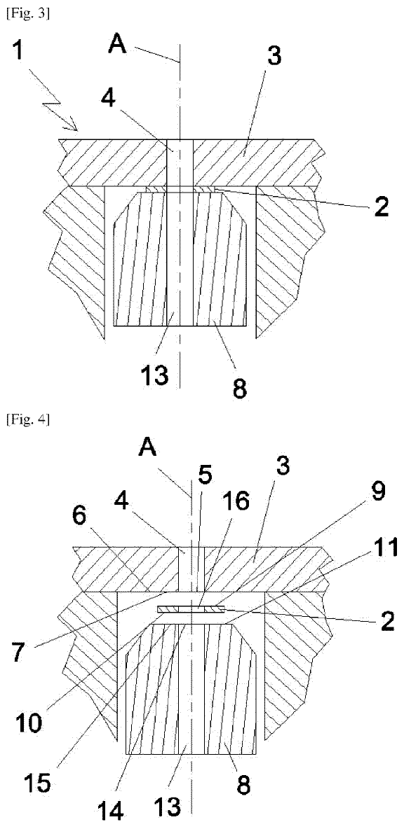

Referring to FIG. 3, one can see a flat static seal 2 placed between a first mechanical component 3 and a second mechanical component 8, according to an example of the invention's embodiment wherein the static seal allows ensuring sealing of the fluid continuity between a duct 4 of the first component 3 and a duct 13 of the second component 8, intended to receive a cryogenic liquid, the seal being shown in working position.

Referring to FIG. 4, one can see the same flat static seal 2 as in FIG. 3, but in an assembly position facilitating the description of the invention. The second mechanical component 8 has a duct 13 with an opening 14 in one end 15 of the second mechanical component. The seal has an opening 16 connecting openings 5, 14 of the first and second mechanical components. The seal includes a first face 9 intended to bear against a contact surface 7 of the first component 3. It also includes a second face 10 intended to bear against a contact surface 11 of the second component 8. In this example, the seal must ensure sealing on its two faces 9, 10 opposite. The two contact surfaces 7, 11 thus include closed grooves according to the invention. As in the example shown in FIG. 1, after positioning the seal between the two mechanical components, a tightening force is applied by the two mechanical components to compress the seal. The compression of the seal and its elastic material will allow the two support faces to perfectly match the contact surfaces of the two mechanical components. Thus, the seal fills the channels 17 of both contact surfaces and their protruding edges imprint into the seal, forming successive barriers, preventing liquid flow between the two faces of the seal and the contact surfaces of the mechanical components. The sealing during the passage of a cryogenic liquid from duct 4 to duct 13 is thus assured.

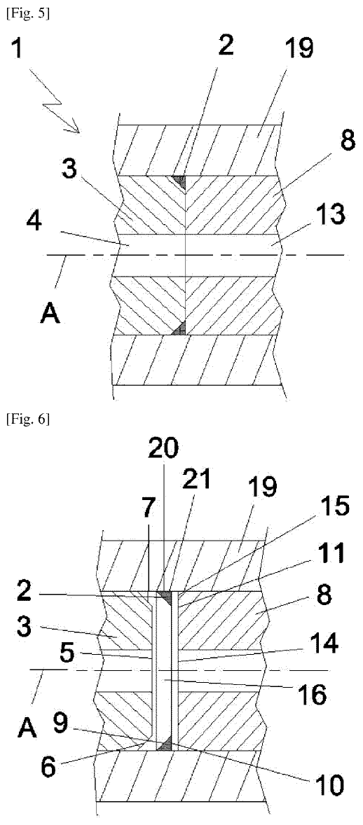

Referring to FIG. 5, one can see a triangular section static seal 2 placed between a first mechanical component 3, a second mechanical component 8, and a third mechanical component 19 according to an example of the invention's embodiment wherein the static seal allows ensuring fluid continuity between a duct 4 of the first component 3 and a duct 13 of the second component 8, the seal being shown in working position. The housing wherein the seal is placed, formed by the three mechanical components, has a triangular section.

Referring to FIG. 6, one can see the same static seal 2 as in FIG. 5, but in an assembly position facilitating the description of the invention. The seal includes a first face 9 intended to bear against a contact surface 7 of the first component 3. It includes a second face 10 intended to bear against a contact surface 11 of the second component 8. It also includes a third face 20 intended to bear against a contact surface 21 of the third component 19. In this example, the seal must ensure sealing on its two faces 9, 10 opposite. This function being assured on these two faces, the third face 20 of the seal does not need to ensure sealing. It is nevertheless advantageous that it also ensures sealing to reinforce the global sealing obtained by the seal. Only the two opposite contact surfaces 7, 11 include closed grooves according to the invention. The third contact surface 21 is perfectly smooth and thus has no grooves.

The third contact surface serves notably as guidance during seal installation. Thus, the third face 20 of the seal slides on the contact surface 21 of the third mechanical component during seal installation during pump assembly. The sliding of the third face of the seal on the contact surface of the third mechanical component can also result from differential dilation of the third mechanical component relative to the other two. If grooves were present on the third mechanical component, they would damage the seal through an effect similar to machining.

Advantageously, the seal has a triangular section slightly larger than that of the housing where it is placed. Thus, during seal compression by tightening of the first two components 3, 8, the force exerted by the two contact surfaces, those including closed grooves according to the invention, causes deformation of the seal toward the third contact surface. This configuration allows optimally filling the volume wherein the seal is placed while ensuring good contact between the seal and all contact surfaces.

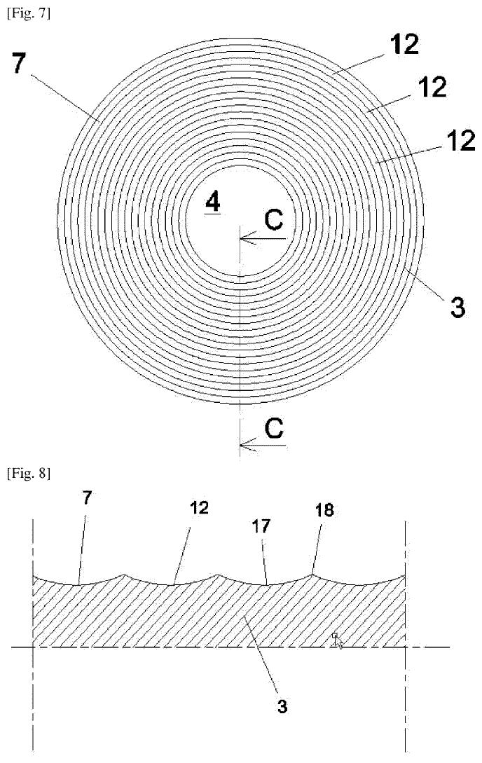

Referring to FIG. 7, one can see represented, in top view, the contact surface 7 of a mechanical component 3 comprising a plurality of closed grooves 12 according to an example of the invention's embodiment.

The contact surface surrounds a duct 4 intended to receive a cryogenic liquid. In this example, the closed grooves are circular and concentric around axis A of duct 4, with a constant distance between two grooves along the length of the grooves and a constant distance between two successive grooves. The grooves could be non-circular, of any shape. Thus, the distance from a groove to the axis of duct 4 can vary along the length of the groove. Similarly, the distance between two grooves can vary along the length of the grooves, these being closer in some places and more distant in others.

The distance between two successive grooves can also be different, these being, for example, closer near duct 4 and more distant at the exterior of the contact surface. The only constraint is that the grooves must be closed to block the flow of cryogenic liquid.

Referring to FIG. 8, one can see partially represented the contact surface of FIG. 7, in cross-section according to plane CC represented in FIG. 7. The closed grooves 12 present on contact surface 7 include a protruding edge forming a ridge 18 between two closed channels 17.

1. A pump for cryogenic liquids comprising at least one static seal suitable for ensuring sealing between a first mechanical component and a second mechanical component, the first mechanical component having a duct intended to contain cryogenic liquid with an opening in one end of the first mechanical component, said end of the first mechanical component having a contact surface, the seal having a first face bearing against the contact surface of the first mechanical component and a second face bearing against a contact surface of the second mechanical component arranged at one end of said second mechanical component,
wherein the contact surface of the first mechanical component comprises at least one closed groove surrounding the opening in the end of the first mechanical component, in that the second mechanical component has a duct intended to contain cryogenic liquid with an opening in the end of the second mechanical component, the seal having an opening connecting the openings of the first and second mechanical component, and
in that the contact surface of the second mechanical component comprises at least one closed groove surrounding the opening- in the end of the second mechanical component.

2. The pump according to claim 1, wherein the contact surface of the first mechanical component comprises a plurality of successive closed grooves starting from the opening of duct of the first mechanical component, a first groove being closest to the opening, the second groove and subsequent ones surrounding the groove(s) positioned closer to the opening of duct of the first mechanical component.

3. The pump according to claim 1, wherein the contact surface of the second mechanical component comprises a plurality of multiple successive closed grooves starting from the opening of the second mechanical component, a first groove being closest to the opening, the second groove and subsequent ones of the contact surface of the second mechanical component surrounding the groove(s) the surface of the contact surface of the second mechanical component positioned closer to the opening in the end of the second mechanical component.

4. The pump according to claim 2, wherein the closed grooves are concentric.

5. The pump according to claim 1, wherein the closed grooves form closed channels delimited by protruding edges.

6. The pump according to claim 1, the static seal also ensures sealing with a third mechanical component, the seal having a third face bearing against a contact surface of the third mechanical component, wherein the contact surface of the third mechanical component is devoid of grooves.

7. The pump according to claim 6, wherein the static seal forms a triangular section torus.

8. The pump according to claim 1, wherein the static seal is made of polymer.

9. The pump according to claim 8, wherein the static seal is made of Polytetrafluoroethylene (PTFE).

10. The pump according to claim 8, wherein the static seal is made of Polychlorotrifluoroethylene (PCTFE).

11. The pump according to claim 8, wherein the static seal is made of polyimide.

12. The pump according to claim 1, wherein it is suitable for pumping liquid hydrogen.
